(19) United States
(12) Patent Application Publication
(10) Pub. No.: US 2026/0091721 A1
(43) Pub. Date: Apr. 2, 2026

(54) RAMP MOUNTED ABOVE A VEHICLE CABIN

(71) Applicant: The Braun Corporation, Winamac, IN (US)

(72) Inventor: Adam Wojdyla, Carmel, IN (US)

(73) Assignee: The Braun Corporation, Winamac, IN (US)

(21) Appl. No.: 19/315,997

(22) Filed: Sep. 2, 2025

Related U.S. Application Data
(60) Provisional application No. 63/701,044, filed on Sep. 30, 2024.

(51) Int. Cl. B60P 1/43; A61G 3/06

(52) U.S. Cl. CPC B60P 1/43; A61G 3/061

(57) ABSTRACT

An accessibility device for transporting wheelchaired passengers in a vehicle is provided. The accessibility device may be a wheelchair ramp, wheelchair lift, or a swivel seat, and may be configured to move from a stowed position on top of the roof of the vehicle to a deployed position configured to provide entrance for the wheelchaired passenger. The wheelchair ramp may be deployed in such a way that the ramp is supported by the ground and other vehicle structures such that no modification to the roof structure is required. The vehicle may be an autonomous vehicle that may include sensors mounted on or near the roof of the vehicle. The accessibility device may be stowed in such a way that it does not block the sensors for the autonomous vehicle. The accessibility device may further include a cover that protects the accessibility device from weather and decreases drag during driving.

### CROSS-REFERENCE TO OTHER APPLICATIONS

The present disclosure claims priority to U.S. Provisional Patent Application No. 63/701,044, filed on September 30, 2024, the content of which is incorporated by reference.

### FIELD OF THE DISCLOSURE

The present disclosure relates generally to a passenger vehicle that has been modified to allow access by a physically limited passenger, and more particularly to an accessibility device that may deploy to assist a wheelchaired passenger to enter and exit the vehicle and that may stow on top of the vehicle cabin structure.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified altering or adding certain parts or structures within a vehicle to accommodate the physically limited passenger without inconveniencing other passengers or sacrificing space in the vehicle. For example, in one configuration, a passenger vehicle may be retrofitted with an accessibility device such as a ramp or a lift to enable a physically limited individual using a personal mobility device to enter and exit the vehicle.

In some cases, the accessibility device is stored below the conventional vehicle floor and deploys to accommodate entry and exit of the physically limited individual through an entrance of the vehicle. This typically requires extensive modification such as removing the OEM floor and replacing it with a custom lowered floor. Modern electrically powered vehicles often store the battery below the vehicle floor, presenting challenges for the lowered floor method of modification.

In other instances, an accessibility device may stow inside the vehicle interior. While this simplifies the modification of the vehicle, it is often not desired to take up interior space for passengers or other cargo. Many times, these fold-up type ramps in their stowed position will also block entry to the vehicle by non-wheelchaired passengers.

Autonomous vehicles often use a plurality of sensors. These sensors may be mounted on or adjacent to the roof structure of the vehicle. These sensors typically are faced outwards to scan the world around the vehicle so that the vehicle can autonomously drive. It is crucial that any exterior mounted structure not impede the vision of these sensors.

### SUMMARY OF THE EMBODIMENTS

In one embodiment, an accessibility device is stowed exterior of the vehicle cabin on top of the roof. A deployment mechanism may deploy the accessibility device such that it facilitates entry or exit of the vehicle for a passenger using a personal mobility device.

In an example of this embodiment, the accessibility device may be a ramp. For one method of modification of the vehicle, there may not be additional structural supports for the roof of the vehicle. The ramp may deploy in such a way that one end of the ramp is supported by the ground and the opposite end of the ramp is supported by the vehicle. By supporting the ramp in such a way, the weight of a person traversing the ramp may be dispersed instead of translating to force applied to the roof structure.

In another example of this embodiment, the vehicle may be further modified to include structural support for the accessibility device. Structural support may be added to the roof or may reinforce the contact point between the end of the ramp and the vehicle.

In another example of this embodiment, the ramp platform may be made up of more than one structure. The more than one platform structures may be connected by a hinging device or any other known method of compacting a platform structure for storage. When stowed, the ramp platform may be folded to a smaller footprint about the hinging device. The deploying mechanism may unfold the ramp platform during the deployment process and fold the ramp platform during the stowing process.

In another embodiment, the accessibility device may be a lift that may be operated manually with a controller by a passenger, or autonomously. The lift may deploy to the ground to facilitate a passenger boarding the lift platform. The lift may then raise to the vehicle floor height for the passenger to enter the vehicle. A disembarking process of the opposite steps is contemplated.

In another embodiment, the roof-mounted accessibility device may be covered or housed in a way such that the aerodynamic drag of the accessibility device on top of the roof may be reduced to improve driving efficiency. Housing the accessibility device may also assist in protecting it against weather conditions in regions where some vehicles may operate. It is contemplated that a housing or cover could open up as part of the accessibility device deployment steps to make way for it to deploy and close at the end of the stowing process.

In another embodiment, a roof-mounted accessibility device may be used in autonomous vehicles, or AVs. AVs require many sensors to scan the world around them in order to make decisions and operate the vehicle safely without human intervention. For the best line of sight, AVs often mount at least some of the many sensors on the roof of the vehicle. These sensors are typically pointed outwards from the vehicle such that they can monitor the landscape around the vehicle. Therefore, an accessibility device mounted in the center of the vehicle’s roof may avoid blocking the sensors. AVs may be electrically powered and as previously mentioned, the battery location underneath the vehicle makes it difficult to fit an in-floor ramp.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a perspective view of a passenger vehicle modified with a roof-top ramp assembly for accessibility access with a ramp platform in a stowed position.

FIG. 2 illustrates a perspective view of the passenger vehicle of FIG. 1 with the ramp platform in a deployed position.

FIG. 3 illustrates a perspective view of an autonomous passenger vehicle modified with the roof-top ramp assembly of FIG. 1 with the ramp platform in a stowed position.

FIG. 4 illustrates a perspective view of the autonomous passenger vehicle of FIG. 3 with the ramp platform in a deployed position.

FIG. 5 illustrates a perspective view of the autonomous passenger vehicle of FIGS. 3 and 4 with the ramp platform in a stowed position inside a housing assembly.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

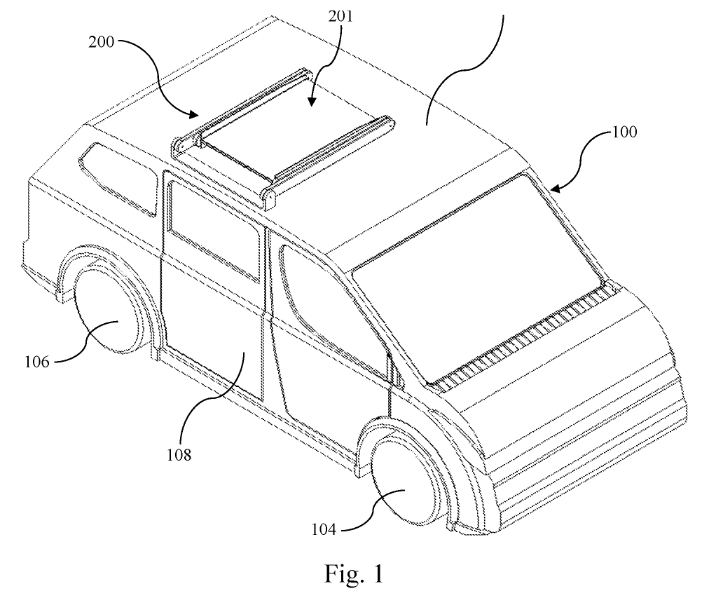

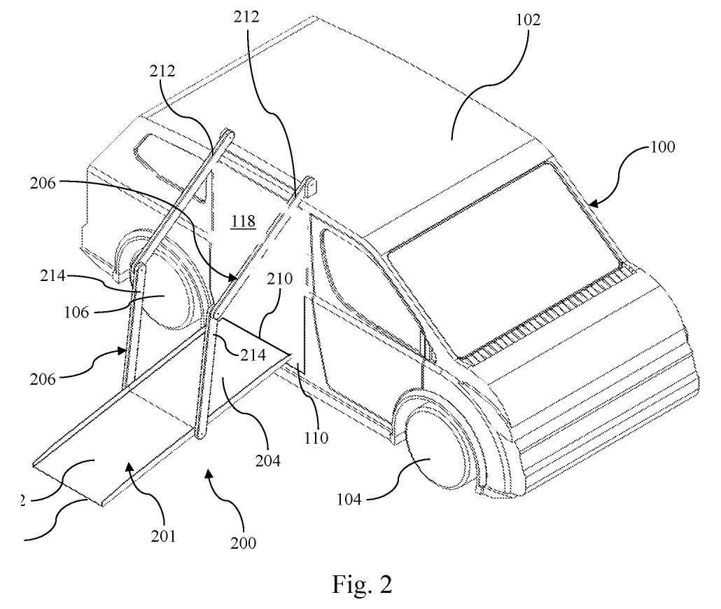

FIGS. 1 and 2 illustrate a passenger vehicle 100 modified to provide transport for physically limited passengers. The vehicle 100 may be supported by front wheels 104 and rear wheels 106, and has a roof 102 enclosing the interior of the vehicle 100. An accessibility device, illustrated as a ramp assembly 200, may be mounted on top of the roof 102. The ramp assembly 200 may be mounted above an accessibility entrance door 108. The accessibility entrance door 108 is shown as a second row door of vehicle 100, but the accessibility entrance door 108 may be a front row door or a rear (e.g., tailgate) entrance door in other configurations of vehicle 100.

The ramp assembly 200 may be powered or manual. A ramp assembly 200 may be hydraulically, electrically, pneumatically powered, or any other well known method for powering accessibility devices, for moving a ramp platform 201 of the ramp assembly 200 between stowed and deployed positions and moving a platform 201 comprising multiple sections from a collapsed position to an expanded position. In other implementations, the ramp assembly 200 may be manually operable by hand between stowed and deployed positions and the platform 201 may be manually operable by hand between collapsed and expanded positions.

FIG. 1 illustrates a ramp platform 201 of the ramp assembly 200 in the stowed position on top of the roof 102. FIG. 2 illustrates the ramp platform 201 in the deployed position to facilitate entrance to the vehicle 100. In the deployed position, the ramp platform 201 extends from the ground level at a first, outboard end 208 to the floor level of the vehicle 100 at a second, inboard end 210, whereby a wheelchaired passenger is provided rolling access to the interior of the vehicle. The ramp platform 201 may comprise a single structure or, as shown, multiple structures that collapse as the ramp platform 201 moves from the deployed position to the stowed position. As shown in FIG. 2, the ramp assembly 200 has a first platform section 202 and a second platform section 204. The first and second platform sections 202, 204 may be pivotably coupled together via a hinge or the like, whereby the first and second platform sections 202, 204 can move between a collapsed (e.g., folded) position when stowed and an expanded (e.g., unfolded) position when deployed. Other known structures for collapsing (e.g., stacking) multiple platform structures for storage are contemplated, such as sliding or telescoping mechanisms. In their expanded and deployed position, the first and second platform sections 202, 204 define a continuous, rigid platform 201 extending from ground level to floor level that a wheelchaired passenger may traverse to enter the vehicle 100. When stowed, the first and second platform sections 202, 204 may collapse to reduce the size of the ramp assembly 200 on top of the roof 102.

The ramp assembly 200 may deploy from the stowed position through motion of a at least one deployment mechanism 206, which as shown may take form as a linkage assembly configured to support and guide the platform 201 between the stowed and deployed positions. As shown, the ramp assembly includes two linkage assemblies. Each linkage assembly may comprise any number of links, including as shown, a first link 212 pivotably coupled to the roof 102 of the vehicle and a second link 214 pivotably coupled between the first link 212 and the platform 201. The deployment mechanism 206, or a separate mechanism, may also be configured to expand and collapse the ramp platform 201 if it comprises more than one platform section as illustrated.

While in the deployed position as shown in FIG. 2, the accessibility entrance door is opened (not shown) to make way for a passenger to enter accessibility entrance 118. With the accessibility door out of the way, the inboard end 210 of the platform 201 may rest on the door jamb 110, on the interior floor, or other structure adjacent the door jamb, whereby the inboard end 210 of the platform is substantially flush (i.e., within ADA standards) with the vehicle floor. The outboard end 208 of the platform 201 may rest on the ground. In one embodiment, the load of a user on the ramp platform 201 is supported entirely by the ramp platform and is isolated from the deployment mechanism 206 and roof 102. In that respect, the deployment mechanism 206 and roof 102 need only be designed to support the weight of the platform 201 as it moves between the stowed and deployed positions. It is contemplated that additional structure may be needed to support the load of ramp assembly 200 resting on the door jamb 110. In other modification methods, the roof 102 may be reinforced and the deployment mechanism made more robust to support the weight of a wheelchaired passenger on the ramp assembly 200.

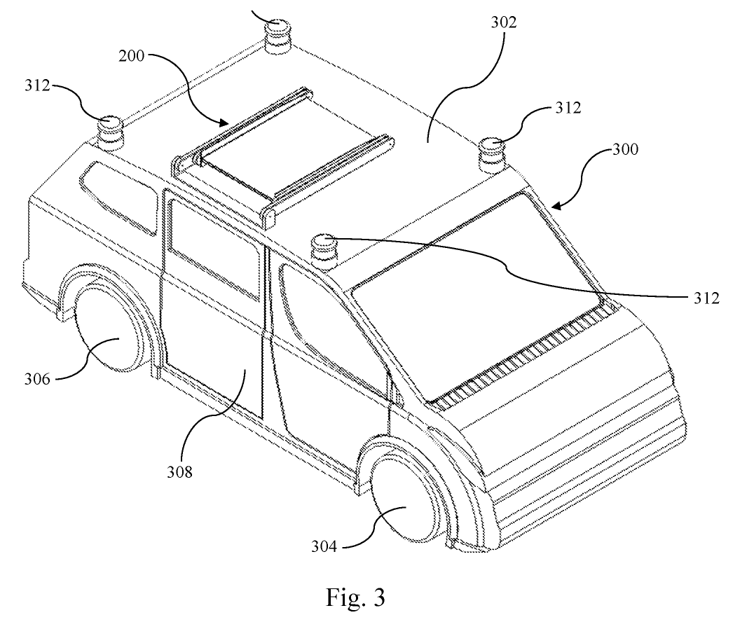

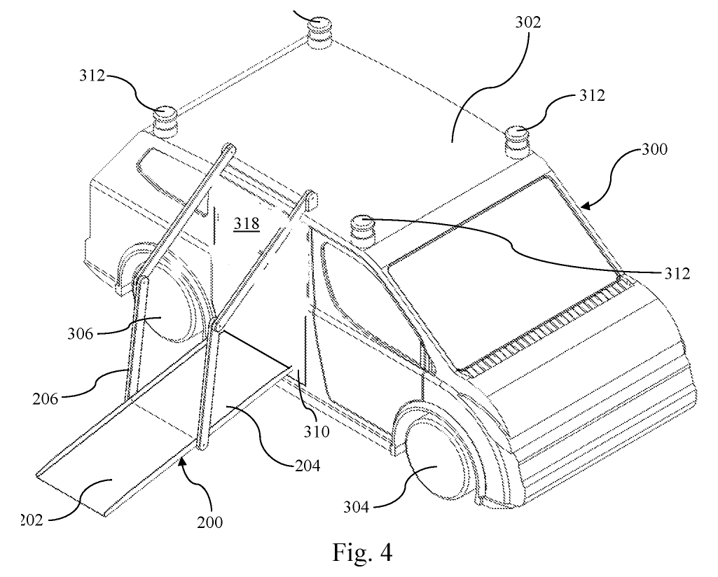

FIGS. 3 and 4 illustrate an autonomous vehicle 300 modified to provide transport for physically limited passengers. The autonomous vehicle 300 may be supported by front wheels 304 and rear wheels 306, and has a roof 302 enclosing the interior of the vehicle 300. An accessibility device, illustrated as a ramp assembly 200, may be mounted on top of the roof 302. The ramp assembly 200 may be substantially the same as the ramp assembly 200 described above for FIGS. 1-2. The ramp assembly 200 may be mounted above an accessibility entrance door 308. The accessibility entrance door 308 is shown as a second-row door of vehicle 300, but the accessibility entrance door 308 may be a front-row door or a rear entrance door in other configurations of autonomous vehicle 300.

Autonomous vehicle 300 may include one or more sensors 312 mounted on top of roof 302 around the edges. Ramp assembly 200 may be stowed in a compact position such that it does not obstruct the view of any of the sensor structures 312.

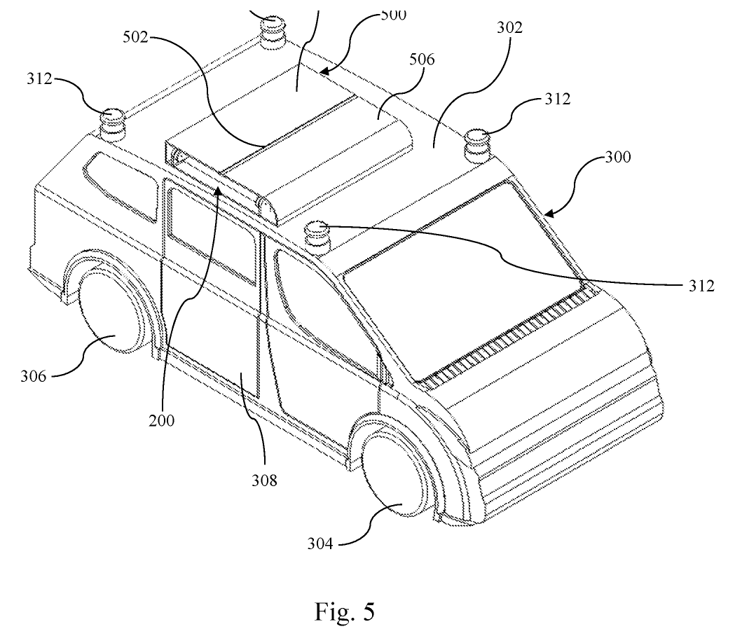

FIG. 5 illustrates the ramp assembly 200 installed on the roof structure 302 of autonomous vehicle 300. The ramp assembly 200 may include a housing assembly 500 such to provide protection from the weather and decrease drag while the autonomous vehicle 300 is driving. The housing assembly 500 is moveable between an open position and a closed position. As shown, the housing assembly 500 may open up at a seam 502 where a first top 504 and a second top 506 may unfold to allow deployment of the ramp assembly 200. The housing assembly 500 may open up at seam 502 as the first step in the deployment process before the ramp assembly 200 begins movement and close after the ramp assembly 200 has completely stowed during the stowing process. The opening and closing process may be powered or manual. Other structures and methods of opening and closing the housing assembly 500 to facilitate deployment are contemplated.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A passenger vehicle modified for transporting mobility restricted passengers, the vehicle comprising:
an accessibility entrance having a door and a door jamb;
a roof structure;
an interior floor;
an accessibility device;
wherein the accessibility device is mounted on top of the roof structure.

2. The vehicle of claim 1, wherein the accessibility device comprises a deployment mechanism to move the accessibility device between a stowed position a deployed position, and from the deployed position back to the stowed position.

3. The vehicle of claim 2 wherein the accessibility device is mounted on the roof adjacent the accessibility entrance.

4. The vehicle of claim 3, wherein the accessibility device is a ramp, the ramp comprising a platform having a first end and a second end.

5. The vehicle of claim 4, wherein in the deployed position, the first end of the ramp platform rests on the ground adjacent to the vehicle and the second end of the ramp platform rests on the vehicle.

6. The vehicle of claim 5 wherein the second end of the ramp platform rests on a door jamb of the accessibility entrance.

7. The vehicle of claim 5 wherein the second end of the ramp platform rests on the interior floor of the vehicle.

8. The vehicle of claim 4, wherein the ramp platform is more than one piece.

9. The vehicle of claim 8, wherein the ramp platform pieces are connected via a hinge such that in the stowed position, the ramp platform is folded into a small package.

10. The vehicle of claim 9, wherein deployment mechanism is configured to unfold and fold the ramp platform pieces during the movement from the stowed position to the deployed position.

11. The vehicle of claim 3, wherein the accessibility device further comprises a cover, the cover being opened up during the deployment process to facilitate free movement of the accessibility device.

12. An accessibility device configured to be installed on a vehicle, the vehicle comprising:
a roof structure;
an accessibility entrance comprising a door jamb;
an interior floor;
wherein the accessibility device is configured to mount on the roof of a vehicle.

13. The accessibility device of claim 12, wherein the accessibility device comprises a deployment mechanism to move the accessibility device between a stowed position and a deployed position, and from the deployed position back to the stowed position.

14. The accessibility device of claim 13 wherein the accessibility device is mounted on the roof adjacent the accessibility entrance.

15. The accessibility device of claim 14, wherein the accessibility device is a ramp, the ramp comprising a platform having a first end and a second end.

16. An autonomous vehicle modified to provide transport for passengers in a wheelchair, the autonomous vehicle comprising:
a roof structure;
an accessibility entrance having a door and a door jamb;
an interior floor;
one or more sensors;
wherein the one or more sensors are mounted on or near the roof structure of the autonomous vehicle; and,
an accessibility device mounted to the roof structure of the autonomous vehicle adjacent the accessibility entrance.

17. The autonomous vehicle of claim 16, wherein the accessibility device comprises a deployment mechanism to move the accessibility device between a stowed position and a deployed position, and from the deployed position back to the stowed position.

18. The autonomous vehicle of claim 17, wherein the accessibility device is mounted on the roof structure of the autonomous vehicle in a way that does not block the one or more sensors.

19. The autonomous vehicle of claim 18, wherein the accessibility device is a ramp, the ramp comprising a platform having a first end and a second end.

20. The autonomous vehicle claim 19, wherein the accessibility device further comprises a cover, the cover being opened up during the deployment process to facilitate free movement of the accessibility device.
